(19) United States
(12) Patent Application Publication
(10) Pub. No.: US 2020/0191084 A1
(43) Pub. Date: Jun. 18, 2020

(54) METHOD AND DEVICE FOR THE EXHAUST AFTERTREATMENT OF AN INTERNAL COMBUSTION ENGINE

(71) Applicant: VOLKSWAGEN AKTIENGESELLSCHAFT, Wolfsburg (DE)

(72) Inventors: Falk-Christian BARON VON CEUMERN-LINDENSTJERNA, Braunschweig (DE); Christoph Nee, Wolfsburg (DE); Michael Kaack, Rotgesbuttel (DE); Stefan Paukner, Wolfsburg (DE)

(73) Assignee: VOLKSWAGEN AKTIENGESELLSCHAFT, Wolfsburg (DE)

(21) Appl. No.: 16/710,812

(22) Filed: Dec. 11, 2019

(30) Foreign Application Priority Data
Dec. 17, 2018 (DE) 10 2018 132 466.9

(51) Int. Cl. F02D 41/14; F01N 3/32; F02D 41/06; F01N 3/10; F01N 3/34

(52) U.S. Cl. CPC F02D 41/1454; F01N 3/32; F02D 41/062; F02D 2200/0802; F01N 3/101; F01N 3/34; F02D 41/1441

(57) ABSTRACT

The invention relates to a method for exhaust aftertreatment of an internal combustion engine with at least one combustion chamber and an outlet that is connected to an exhaust system, wherein at least one catalytic converter is arranged in the exhaust system. Furthermore, a secondary-air system is provided with which secondary air can be introduced into an exhaust duct of the exhaust system at an intake point downstream from the outlet of the internal combustion engine and upstream from the catalytic converter, and a first lambda sensor is arranged in the exhaust duct downstream from the intake point and upstream from the catalytic converter. The internal combustion engine is operated immediately after start-up with a substoichiometric combustion air ratio (λ E<1), and secondary air is introduced into the exhaust duct of the exhaust system downstream from an outlet of the internal combustion engine and upstream from the first lambda sensor. An exhaust-gas lambda is determined by the first lambda sensor and a stoichiometric exhaust-gas lambda (λ m=1) set, with the quantity of secondary air being maintained constant and the quantity of fuel being adjusted such that the stoichiometric exhaust-gas lambda (λ m=1) is achieved.

### FIELD OF THE INVENTION

The invention relates to method for exhaust aftertreatment of an internal combustion engine as well as to a device for carrying out such a method according to the preamble of the independent claims.

### BACKGROUND OF THE INVENTION

Current exhaust gas legislation places high demands on the engine raw emissions and exhaust aftertreatment of internal combustion engines, and these demands will become stricter in the future. In this regard, the period immediately after a cold start of the internal combustion engine has special significance in terms of emissions, since the exhaust aftertreatment components should be heated as quickly as possible to their operating temperature in this phase in order to allow efficient exhaust aftertreatment. In gasoline engines in particular, the heating of an engine-compartment three-way catalytic converter is crucial for the emissions of a motor vehicle. Internal combustion engines with a secondary-air system are known from the prior art in which secondary air is introduced into the exhaust system downstream from an outlet of the internal combustion engine and upstream from the three-way catalytic converter in order to heat the three-way catalytic converter.

An internal combustion engine from having a catalytic converter system is known DE 103 38 935 A1 in which secondary air is introduced into the exhaust system in order to heat the catalytic converter system during a warm-up phase of the internal combustion engine. A provision is made that, at least during the warm-up phase, the air mass flow and the secondary-air mass flow supplied to the combustion chambers of the internal combustion engine are determined, and the combustion air ratio of the internal combustion engine is set as a function of these mass flows.

An internal combustion engine with an exhaust system and a secondary-air system is known from DE 10 2016 218 818 A1. In that document, a method for controlling the internal combustion engine is proposed in which a secondary-air quantity that is introduced into the exhaust system is determined and sent to the engine control unit. In this case, the combustion air ratio is set as a function of the determined secondary-air quantity such that a predetermined exhaust gas air ratio is established in the exhaust gas system.

An exhaust system for an internal combustion engine is known from EP 1 970 546 A1. The exhaust system has an exhaust duct that can be connected to an outlet of the internal combustion engine. In the exhaust system, a first catalytic converter and a second catalytic converter as well as a secondary-air system are provided with which secondary air is introduced downstream from the first catalytic converter and upstream from the second catalytic converter in the exhaust duct of the exhaust system.

One disadvantage of the known exhaust aftertreatment systems, however, is that these systems allow for only pure precontrol of the secondary-air quantity and have no control system for a constant secondary-air quantity. Therefore, a not exactly known quantity of air is introduced into the exhaust system, which is influenced by external environmental conditions and thus has the effect during closed-loop air-fuel ratio control that targeted, emissions-optimized lambda regulation is not achieved.

It is the object of the invention to propose a method for exhaust aftertreatment that further reduces the emissions in the cold-start phase compared to the methods that are known from the prior art.

### SUMMARY OF THE INVENTION

According to the invention, this object is achieved by a method for exhaust aftertreatment of an internal combustion engine with at least one combustion chamber and an outlet that is connected to an exhaust system, at least one catalytic converter being arranged in the exhaust system, as well as with a secondary-air system with which secondary air can be introduced at an intake point downstream from the outlet and upstream from the catalytic converter in an exhaust duct of the exhaust system, a first lambda sensor being arranged in the exhaust duct downstream from the intake point and upstream from the catalytic converter, comprising the following steps:
Starting the internal combustion engine, the internal combustion engine being operated immediately after start-up with a substoichiometric combustion air ratio,
introducing secondary air into the exhaust duct of the exhaust system downstream from an outlet of the internal combustion engine and upstream from the first lambda sensor,
determining an exhaust-gas lambda by means of the first lambda sensor,
setting a stoichiometric exhaust-gas lambda,
with the ratio between the exhaust-gas quantity and secondary-air quantity being maintained constant, and with the amount of fuel introduced into the at least one combustion chamber being adjusted such that the stoichiometric exhaust-gas lambda is achieved.

The proposed method makes it possible to regulate the combustion air ratio of the internal combustion engine such that optimum emissions are achieved with maximum heating effect. For this purpose, the exhaust-gas lambda is determined during the heating phase of the catalytic converter, and the deviation from a stoichiometric combustion air ratio is converted into a correction value for the fuel mixture. The correction can thus be performed by adjusting the quantity of fuel that is injected into the combustion chambers of the internal combustion engine that makes the emissions-neutral exhaust-gas lambda of 1—that is, a stoichiometric exhaust gas—available in conjunction with the secondary air being introduced.

Advantageous improvements and developments of the method for exhaust aftertreatment specified in the independent claim can be advantageously improved and non-trivially further developed by the features cited in the dependent claims.

In a preferred embodiment of the invention, a provision is made that the first lambda sensor is embodied as a wideband lambda sensor, with the residual oxygen content of the exhaust-gas lambda being determined quantitatively. Through the use of a wideband lambda sensor as the first lambda sensor, a measurement of the residual oxygen content can be performed during the heating phase. This information can be used to control the combustion chamber mixture control. The method is carried out until the catalytic converter has reached an operating temperature at which, with a stoichiometric combustion air ratio in the combustion chambers of the internal combustion engine, efficient exhaust aftertreatment is possible.

In an advantageous embodiment of the method, a provision is made that the first lambda sensor is electrically heated immediately after the starting of the internal combustion engine. By heating the lambda sensor, the lambda sensor can be brought into operational readiness independently of the external ambient conditions and thus makes it possible to efficiently control the exhaust-gas lambda promptly after a cold start.

In a preferred embodiment of the invention, a provision is made that continuous measurement of the residual oxygen content in the mixed exhaust gas is performed downstream from the intake point. Continuous measurement enables the regulation to be further improved and the accuracy of the method to be improved.

In an advantageous embodiment of the method, a provision is made that the internal combustion engine is operated with a combustion air ratio λ E that lies between 0.7 and 0.85. A combustion air ratio λ E of just above the rich combustion limit of the fuel-air mixture in the combustion chambers enables especially rapid and efficient heating of the exhaust system and of the exhaust treatment components that are arranged in the exhaust system to be achieved.

In another preferred embodiment of the invention, a provision is made that the secondary-air supply is shut off and the internal combustion engine is operated with a stoichiometric combustion air ratio if the catalytic converter has reached a threshold temperature. This makes it possible to switch to an operating condition with lower raw emissions and increased efficiency of the internal combustion engine once the threshold temperature is reached. The duration of the heating mode for the catalytic converter can thus be limited and the fuel efficiency of the internal combustion engine enhanced.

If is especially preferred if the threshold temperature is the light-off temperature of a three-way catalytically active coating of the catalytic converter. Starting at the light-off temperature, efficient conversion of pollutants in the exhaust gas of the internal combustion engine by the catalytic converter can be ensured. Further heating can take place through an exothermic reaction of unburned exhaust gas components, particularly unburned hydrocarbons and carbon monoxide on the catalytically active surface of the catalytic converter.

Moreover, the regulation of the method makes it possible to identify whether, due to speed and load changes in the internal combustion engine, secondary air can no longer be introduced and thus targeted mixture adaptation performed. Likewise, an alternative point for terminating the method can be determined from this condition.

According to the invention, an internal combustion engine is proposed that comprises at least one combustion chamber and an outlet that is connected to an exhaust system, with at least one catalytic converter being arranged in the exhaust system, as well as a secondary-air system with which secondary air can be introduced downstream at an intake point of the outlet and upstream from the catalytic converter in an exhaust duct of the exhaust system, a first lambda sensor being arranged in the exhaust duct downstream from the intake point and upstream from the catalytic converter, as well as an engine control unit that is configured to carry out a method according to the invention if a machine-readable program code is being executed by the engine control unit. By virtue of such an internal combustion engine, cold-start emissions can be reduced. Furthermore, in an internal combustion engine with such an exhaust aftertreatment system, heating measures can be initiated so as not to allow the exhaust aftertreatment components to cool below their light-off temperature and thus always ensure efficient conversion of pollutants in the exhaust gas.

In a preferred embodiment of the invention, a provision is made that the catalytic converter is embodied as a three-way catalytic converter or as a four-way catalytic converter. The three-way catalytic converter or the particulate filter with a three-way catalytically active coating is preferably arranged in a position near the engine in the exhaust system in order to reduce the waste heat losses through the exhaust duct. By means of a three-way catalytic converter or a four-way catalytic converter, both unburned exhaust gas components such as carbon monoxide, unburned hydrocarbons, or hydrogen can be oxidized and nitrogen oxides reduced. In this context, a “position near the engine” is to be understood as meaning a position in the exhaust system with an exhaust run length of less than 800 mm, preferably less than 500 mm, between the outlet of the internal combustion engine and an inlet of the catalytic converter.

In a preferred embodiment of the invention, the internal combustion engine is embodied as an internal combustion engine that is supercharged by means of an exhaust gas turbocharger, a turbine of the exhaust gas turbocharger being arranged in the exhaust duct downstream from the outlet and upstream from the catalytic converter. The turbine of the exhaust gas turbocharger mixes the injected secondary air with the exhaust gas, whereby a homogeneous exhaust gas is achieved with a uniform distribution of the unburned exhaust gas components and the residual oxygen from the secondary air. The unburned exhaust gas components can thus be reacted with the oxygen from the secondary-air supply on the catalytically active surface of the catalytic converter.

It is especially preferred that the intake point of the secondary-air system be arranged downstream from the outlet and upstream from the turbine and that the first lambda sensor be arranged downstream from the turbine of the exhaust gas turbocharger and upstream from the catalytic converter. By arranging the lambda sensor downstream from the turbine and the introduction of the secondary air upstream from the turbine, the residual oxygen content is determined in a correspondingly homogeneously mixed exhaust gas/secondary air gas mixture.

In another improvement of the invention, a provision is made that the secondary-air system comprises an electrically driven secondary-air pump. An electrically driven secondary-air pump makes an especially simple and accurate control of the secondary-air quantity possible. The injection of the secondary air can thus be adjusted by means of a control signal of the engine control unit in the conveyed volume flow in order to correct—in case of deviations of the exhaust-gas lambda from the optimal position with a stoichiometric exhaust-gas lambda—not only the quantity of fuel being injected into the combustion chambers of the internal combustion engine but also a permanent or gradual deviation by increasing or reducing the amount of secondary air conveyed.

It is particularly preferred if the secondary-air system has a secondary-air line that connects the secondary-air pump to the intake point, a secondary-air valve being arranged in the secondary-air line. By means of a secondary-air valve, the introduction of secondary air into the exhaust duct can be controlled and an uncontrolled outflow of exhaust gas prevented.

In a preferred embodiment of the invention, a provision is made that a second lambda sensor is arranged in the exhaust duct downstream from the catalytic converter. Rich or lean breakthroughs can be detected by the catalytic converter by means of a second lambda sensor downstream from the catalytic converter, and the secondary-air quantity and/or the quantity of fuel injected into the combustion chambers can be adapted accordingly.

In an advantageous embodiment of the internal combustion engine, a provision is made that the catalytic converter, in particular a three-way catalytic converter or a four-way catalytic converter, is arranged as the first exhaust aftertreatment component in a position close to the engine in the exhaust system, with an additional exhaust aftertreatment component, particularly a particulate filter or an additional catalytic converter, especially preferably an additional three-way catalytic converter, being arranged downstream from the first catalytic converter. By means of a first catalytic converter near the engine and an additional catalytic converter, the volume of the first catalytic converter can be reduced, thereby favoring the heating of the first catalytic converter. As a result, the first catalytic converter reaches its light-off temperature more quickly so that cold-start emissions can be reduced.

Unless otherwise stated in the individual case, the various embodiments of the invention mentioned in this application can be advantageously combined with one another.

### BRIEF DESCRIPTION OF THE DRAWINGS

The invention will be explained below in exemplary embodiments with reference to the accompanying drawing. In the drawing:

FIG. 1 shows a first embodiment of a schematically illustrated internal combustion engine for carrying out a method according to the invention;

FIG. 2 shows a second embodiment of an internal combustion engine for carrying out a method according to the invention;

FIG. 3 shows a diagram of the timing of the lambda control of the internal combustion engine in a method according to the invention; and

FIG. 4 shows a diagram of the timing of the introduction of secondary air in a method according to the invention.

### DETAILED DESCRIPTION OF THE INVENTION

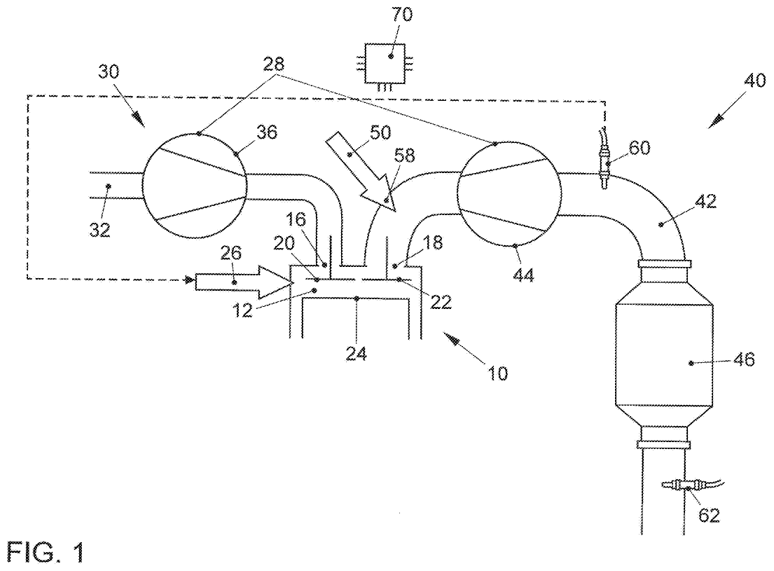

FIG. 1 shows an internal combustion engine 10 with a combustion chamber 12 in which a piston 24 is displaceably arranged. Furthermore, a fuel injector 26 is provided at the combustion chamber 12 in order to inject fuel into the combustion chamber 12. The internal combustion engine 10 is connected at its intake 16 to an air intake system 30. The air intake system 30 comprises an intake line 32 in which a compressor 36 of an exhaust gas turbocharger 28 is arranged. In addition, the internal combustion engine 10 is connected with its outlet 18 to an exhaust system 40. The exhaust system 40 comprises an exhaust duct 42 in which, in the direction of flow of an exhaust gas of the internal combustion engine 10 through the exhaust duct 42, a turbine 44 of the exhaust gas turbocharger 28 is arranged, and, downstream from the turbine 44, at least one catalytic converter 46, preferably a three-way catalytic converter or a particulate filter with a three-way catalytically active coating, which is also referred to as four-way catalytic converter. An intake point 58 is provided downstream from the outlet 18 and upstream from the turbine 44 at which fresh air can be introduced into the exhaust duct 42 by means of a secondary-air system 50. A first lambda sensor 60, which is embodied as a wideband lambda sensor, is arranged downstream from the turbine 44 and upstream from the catalytic converter 46. An additional lambda sensor 62, which is preferably embodied as a two-step sensor, is provided downstream from the catalytic converter 46. The internal combustion engine 10 is also connected to an engine control unit 70 that regulates the fuel injection into the combustion chamber 12 of the internal combustion engine 10 as well as the secondary-air supply.

In order to enable a gas exchange to occur in the combustion chamber 12 of the internal combustion engine 10, at least one intake valve 20 is provided between the combustion chamber 12 and the intake line 32 that allows fresh air to flow into the combustion chamber 12. In addition, an exhaust valve 22 is provided between the combustion chamber 12 and the exhaust duct 42 that enables the exhaust gases to be expelled from the combustion chamber 12 into the exhaust duct 42.

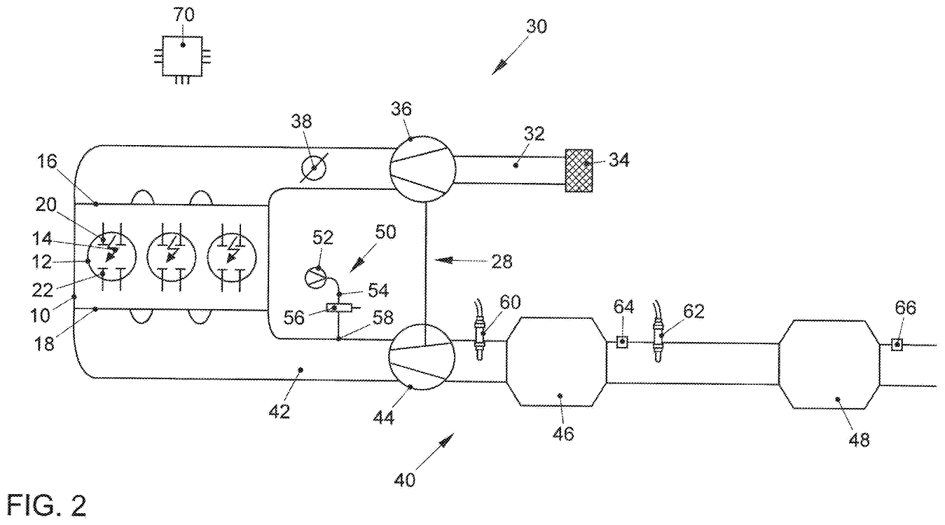

FIG. 2 shows another exemplary embodiment of an internal combustion engine 10 according to the invention. The internal combustion engine 10 has a plurality of combustion chambers 12, at each of which a spark plug 14 for igniting an ignitable fuel-air mixture in the combustion chambers 12 of the internal combustion engine 10 is arranged. The internal combustion engine 10 is connected at its intake 16 to an air intake system 30. The air intake system 30 comprises an intake line 32 in which, in the direction of flow of fresh air through the intake line 32, an air filter 34 is arranged downstream from the air filter 34, a compressor 36 of an exhaust gas turbocharger 28 is arranged downstream from the air filter 34, and—further downstream—a throttle valve 38 is arranged. In addition, the internal combustion engine 10 is connected with its outlet 18 to an exhaust system 40, which has an exhaust duct 42. In the exhaust duct 42 in the direction of flow of an exhaust gas through the exhaust duct 42 are arranged a turbine 44 of the exhaust gas turbocharger 28 and, downstream from the turbine 44, a first catalytic converter 46, particularly a three-way catalytic converter or a particulate filter with a three-way catalytically active coating. A second exhaust aftertreatment component 48, particularly an additional catalytic converter or a particulate filter, is arranged downstream from the first catalytic converter 46. The internal combustion engine 10 also has a secondary-air system 50 with a secondary-air pump 52 that is connected via a secondary-air line 54 to an intake point 58. A secondary-air valve 56 for controlling the secondary air is additionally arranged in the secondary-air line 58. The intake point 58 is situated in the exhaust duct 42 downstream from the outlet 18 and upstream from the turbine 44. A first lambda sensor 60, preferably a wideband lambda sensor, is arranged downstream from the turbine 44 and upstream from the first catalytic converter 46. A second lambda sensor 62 is provided downstream from the first catalytic converter and upstream from the second catalytic converter 48. It is also possible for additional sensors, in particular a temperature sensor 64 or an additional exhaust-gas sensor 66, in particular a NOx sensor, to be arranged in the exhaust system. Alternatively, the first lambda sensor 60 can also be arranged downstream from the intake point 58 and upstream from the turbine 44 of the exhaust gas turbocharger 28. Alternatively, the internal combustion engine 10 can also be embodied as a naturally aspirated engine, in which case the turbine 44 is omitted from the exhaust duct 42 but the sequence of the exhaust aftertreatment components 46, 48 and of the intake point 58 and lambda sensors 60, 62 remains the same.

In order to enable a gas exchange to occur in the combustion chambers 12 of the internal combustion engine 10, intake valves 20 are provided between the combustion chamber 12 and the intake line 32 that allow fresh air to flow into the combustion chambers 12. In addition, exhaust valves 22 are provided between the combustion chamber 12 and the exhaust duct 42 that enable the exhaust gases to be expelled from the combustion chambers 12 into the exhaust duct 42.

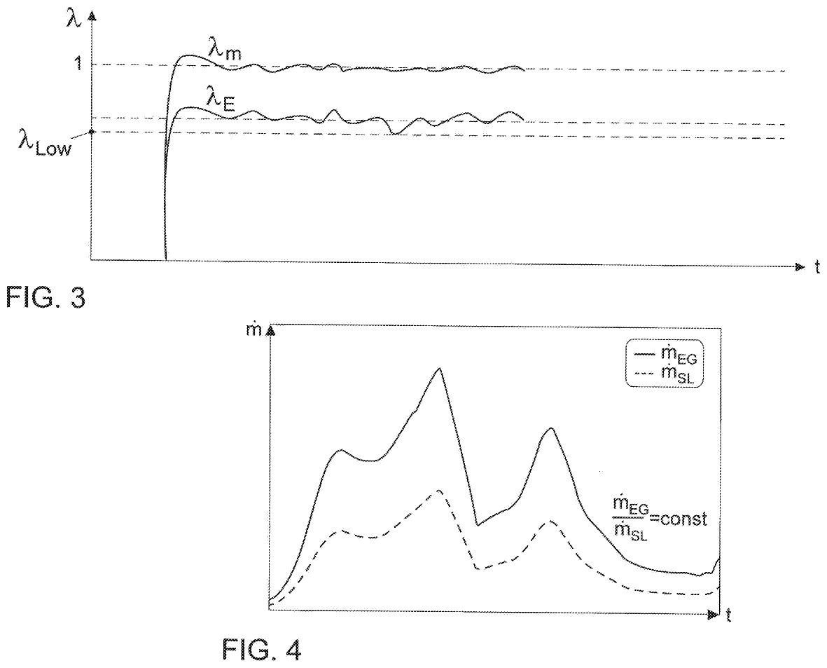

FIG. 3 shows the combustion air ratio λ E and the exhaust-gas lambda λ m from the exhaust gas of the internal combustion engine 10. From start-up S, the internal combustion engine 10 is operated with a substoichiometric combustion air ratio in the range of 0.7<λ E<0.85.

At the same time, secondary air is blown into the exhaust duct 42 by means of the secondary-air system 50. This results in a stoichiometric exhaust-gas lambda, which can be adjusted with precision during the heating phase of the catalytic converter 46.

In FIG. 4, the secondary-air mass flow SL is shown from the start S of the internal combustion engine 10 over time t. As can be seen from FIG. 4, the secondary-air quantity is regulated very precisely here, so that a stoichiometric mixed exhaust lambda λ m is reliably achieved even in dynamic operation with simultaneously high heating power. In the method, the first lambda sensor 60 is made operational prior to or at the beginning of the catalyst heating process. At start-up S of the internal combustion engine 10, a substoichiometric fuel-air mixture is set in the combustion chamber 12. At the same time, a quantity of secondary air designed for the system is introduced downstream from the exhaust valves 22 and upstream from the turbine 44 of the exhaust gas turbocharger 28 by means of the secondary-air system 50. The secondary air is mixed with the exhaust gas from the combustion chambers 12 via the turbine 44 of the exhaust gas turbocharger and guided past the first, already operational lambda sensor 60 downstream from the turbine 44.

The exhaust gas from the combustion chambers 12 is preferably set such that the greatest possible heating power is achieved but a sufficiently large distance is maintained from the rich combustion limit in order to obtain a suitable control range. The control range is maintained both in the direction of the rich combustion limit in order to avoid misfiring and in the direction of stoichiometric exhaust gas in order to avoid reduced heat output. The detected exhaust-gas lambda λ m is detected in the control circuit and converted to a correction factor for mixture correction in the combustion chamber 12 on the basis of the air mass ratios of combustion and secondary air. The exhaust-gas lambda λ m is thus adjusted to the target value of 1.00.

The central position of the exhaust-gas lambda λ m is influenced inter alia by the state of health of the secondary-air system 50 or the delivery line of the secondary-air system 50. As the exhaust-gas backpressure increases, the system tends to drift toward a substoichiometric exhaust-gas lambda λ m<1 and is roped in by the rapid mixture correction. This means that the optimum emissions for the system are achieved at every juncture of the method.

The process is terminated as soon as the temperature of the catalytic converter 46 provided by a model or temperature sensor 64 has reached or exceeded a threshold value, or if the introduced quantity of secondary air has been reduced due to the selected operating point of the internal combustion engine 10 so far that the heating measure can no longer be effectively implemented.

In a preferred embodiment, the secondary-air system 50 has a controllable secondary-air pump 52. If the injection of the secondary air can be adjusted by means of a signal of the engine control unit 70 in the volumetric flow delivered, it is possible to adjust not only the metered quantity of fuel but also the quantity of secondary air that is conveyed in the event of a deviation of the exhaust-gas lambda from the optimum position. Constant heating power can be provided by means of this setup as the mileage and aging of the overall system progress. Any sooting or leaks in the secondary-air system 50 can thus be compensated for.

In order to prevent cooling of the exhaust system 40, particularly of the exhaust aftertreatment components 46, 48, during vehicle operation in a targeted manner, or in order to reheat a cooled exhaust system 40, the method can also be used during operation of a motor vehicle.

By virtue of the proposed method for exhaust aftertreatment, a regulated supply of secondary air can be provided that is more stable and produces lower emissions over the lifetime of the internal combustion engine than can be achieved by solutions that are known from the prior art. Moreover, corresponding control parameters can be monitored by means of on-board diagnostics and thus offer a possibility for enabling a diagnosis of the exhaust aftertreatment system to be made.

### LIST OF REFERENCE SYMBOLS

10 combustion engine
12 combustion chamber
14 spark plug
16 inlet
18 outlet
20 intake valve
22 exhaust valve
24 piston
26 fuel injector
28 exhaust gas turbocharger
30 air intake system
32 intake line
34 air filter
36 compressor
38 throttle valve
40 exhaust system
42 exhaust duct
44 turbine
46 catalytic converter
48 additional exhaust aftertreatment component
50 secondary-air system
52 secondary-air pump
54 secondary-air line
56 secondary-air valve
58 inlet point
60 first lambda sensor/guide probe
62 second lambda sensor
64 temperature sensor
66 additional exhaust-gas sensor
70 engine control unit
λ E combustion air ratio of the internal combustion engine
λ Low rich combustion limit of the internal combustion engine
λ m exhaust gas air ratio downstream from the secondary-air injection
EG mass flow of the exhaust gas
SL mass flow of secondary air
S start-up of the internal combustion engine
t time

1. A method for exhaust aftertreatment of an internal combustion engine having at least one combustion chamber and an outlet that is connected to an exhaust system, at least one catalytic converter being arranged in the exhaust system, a secondary-air system with which secondary air can be introduced downstream at an intake point of the outlet and upstream from the catalytic converter in an exhaust duct of the exhaust system, and a first lambda sensor being arranged in the exhaust duct downstream from the intake point and upstream from the catalytic converter, comprising the following steps:
starting the internal combustion engine, the internal combustion engine being operated immediately after start-up with a substoichiometric combustion air ratio (λ E<1),
introducing secondary air into the exhaust duct of the exhaust system downstream from an outlet of the internal combustion engine and upstream from the first lambda sensor,
determining an exhaust-gas lambda by means of the first lambda sensor,
setting a stoichiometric exhaust-gas lambda (λ m=1),
with the ratio between the exhaust-gas quantity and secondary-air quantity being maintained constant, and with the amount of fuel introduced into the at least one combustion chamber being adjusted such that the stoichiometric exhaust-gas lambda (λ m=1) is achieved.

2. The method as set forth in claim 1, wherein the first lambda sensor is embodied as a wideband lambda sensor, with the residual oxygen content of the exhaust-gas lambda (λ m) being determined quantitatively.

3. The method as set forth in claim 1, further comprising electrically heating the first lambda sensor immediately after the starting of the internal combustion engine.

4. The method as set forth in claim 1, further comprising performing a continuous measurement of the residual oxygen content in the mixed exhaust gas downstream from the intake point.

5. The method as set forth in claim 1, wherein the internal combustion engine is operated with a combustion air ratio λ E that lies between 0.7 and 0.85.

6. The method as set forth in claim 1, further comprising shutting off the secondary-air supply and operating the internal combustion engine with a stoichiometric combustion air ratio (λ E=1) if the catalytic converter has reached a threshold temperature.

7. The method as set forth in claim 6, wherein the threshold temperature is a light-off temperature of a three-way catalytically active coating of the catalytic converter.

8. An internal combustion engine, comprising:
at least one combustion chamber,
an outlet that is connected to an exhaust system,
at least one catalytic converter arranged in the exhaust system,
a secondary-air system with which secondary air can be introduced at an intake point downstream from the outlet and upstream from the catalytic converter in an exhaust duct of the exhaust system,
a first lambda sensor arranged in the exhaust duct downstream from the intake point and upstream from the catalytic converter, and
an engine control unit configured to carry out a method as set forth in claim 1 upon execution of a machine-readable program code.

9. The internal combustion engine as set forth in claim 8, wherein the catalytic converter is embodied as a three-way catalytic converter or as a four-way catalytic converter.

10. The internal combustion engine as set forth in claim 8,
wherein the internal combustion engine is embodied as an internal combustion engine that is supercharged by means of an exhaust gas turbocharger, and
wherein a turbine of the exhaust gas turbocharger is arranged in the exhaust duct downstream from the outlet and upstream from the catalytic converter.

11. The internal combustion engine as set forth in claim 10,
wherein the intake point of the secondary-air system is arranged downstream from the outlet and upstream from the turbine and
wherein the first lambda sensor is arranged downstream from the turbine of the exhaust gas turbocharger and upstream from the catalytic converter.

12. The internal combustion engine as set forth in claim 8, wherein the secondary-air system comprises an electrically driven secondary-air pump.

13. The internal combustion engine as set forth in claim 12, wherein the secondary-air system has a secondary-air line that connects the secondary-air pump to the intake point, and a secondary-air valve is arranged in the secondary-air line.

14. The internal combustion engine as set forth in claim 8, wherein a second lambda sensor is arranged in the exhaust duct downstream from the catalytic converter.

15. The internal combustion engine as set forth in claim 8, wherein the catalyst is arranged as the first exhaust aftertreatment component in a position near the engine in the exhaust system, and an additional exhaust aftertreatment component is arranged downstream from the first catalyst.
